(19) United States
(12) Patent Application Publication
(10) Pub. No.: US 2026/0288024 A1
(43) Pub. Date: Sep. 24, 2026

(54) IMAGE FORMING APPARATUS

(71) Applicant: FUJIFILM Business Innovation Corp., Tokyo (JP)

(72) Inventors: Yuki YONETOKU, Kanagawa (JP); Takeshi KAWAI, Kanagawa (JP); Yukie HIBI, Kanagawa (JP)

(73) Assignee: FUJIFILM Business Innovation Corp., Tokyo (JP)

(21) Appl. No.: 19/298,167

(22) Filed: Aug. 12, 2025

(30) Foreign Application Priority Data
Mar. 24, 2025 (JP) 2025-049109

(51) Int. Cl. G03G 5/14; G03G 5/047

(52) U.S. Cl. CPC G03G 5/144; G03G 5/047

(57) ABSTRACT

An image forming apparatus includes an electrophotographic photoreceptor that has a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer, a charging device that charges the electrophotographic photoreceptor by applying an alternating current using a charging roll, a direct transfer roll, and a recording medium peeling member that peels a recording medium from the direct transfer roll, in which a resistance value of the undercoat layer is 6.0 log Ω·m or more and 9.5 log Ω·m or less, and a current density of the electrophotographic photoreceptor at 40 V/μm is 0.012 μA/cm² or more and 0.030 μA/cm² or less.

### CROSS-REFERENCE TO RELATED APPLICATIONS

This application is based on and claims priority under 35 USC 119 from Japanese Patent Application No. 2025-049109 filed Mar. 24, 2025.

### BACKGROUND

### (i) Technical Field

The present invention relates to an image forming apparatus.

### (ii) Related Art

JP2012-63740A discloses an image forming apparatus including a plurality of image holders, a transfer belt unit that rotates an endless belt by at least a driven roller and a driving roller, a primary transfer portion that forms a color image on the transfer belt by performing toner transfer from each image holder onto the transfer belt, and a secondary transfer member that includes a secondary transfer portion disposed to face the driving roller and that is used for collectively transferring the color image on the transfer belt onto paper, in which a value of an interval between sheets, that is an interval between sheets of paper, is changed according to the number of sheets of paper simultaneously related to the transfer belt.

### SUMMARY

Aspects of non-limiting embodiments of the present disclosure relate to an image forming apparatus having excellent fogging suppressing property and excellent peeling-discharge streak suppressing property as compared with a case where a resistance value of an undercoat layer is less than 6.0 log Ω·m or more than 9.5 log Ω·m, or a case where a current density of an electrophotographic photoreceptor at 40 V/μm is less than 0.012 μA/cm² or more than 0.030 μA/cm².

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided an image forming apparatus including an electrophotographic photoreceptor that has a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer, a charging device that charges the electrophotographic photoreceptor by applying an alternating current using a charging roll, a direct transfer roll, and a recording medium peeling member that peels a recording medium from the direct transfer roll, in which a resistance value of the undercoat layer is 6.0 log Ω·m or more and 9.5 log Ω·m or less, and a current density of the electrophotographic photoreceptor at 40 V/μm is 0.012 μA/cm² or more and 0.030 μA/cm² or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor used in the present exemplary embodiment;

FIG. 2 is a view schematically showing a configuration of an example of an image forming apparatus according to the present exemplary embodiment; and

FIG. 3 is a schematic enlarged partial cross-sectional view in the example of the image forming apparatus according to the present exemplary embodiment.

### DETAILED DESCRIPTION

The present exemplary embodiment will be described below. The following descriptions and examples merely illustrate the exemplary embodiments, and do not limit the scope of the exemplary embodiments.

In the present specification, a numerical range described using “to” represents a range including numerical values listed before and after “to” as the minimum value and the maximum value respectively.

Regarding the numerical ranges described in stages in the present specification, the upper limit or lower limit of a numerical range may be replaced with the upper limit or lower limit of another numerical range described in stages. In addition, in the present specification, the upper limit or lower limit of a numerical range may be replaced with values described in Examples.

In the present specification, the term “step” includes not only an independent step but a step that is not clearly distinguished from other steps as long as the intended purpose of the step is achieved.

In the present specification, each component may include a plurality of corresponding substances. In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, a main component denotes a major component. In the present specification, the main component denotes a component that occupies 30% by mass or more of the total mass of a mixture obtained by mixing a plurality of components.

### Image Forming Apparatus

The image forming apparatus according to the present exemplary embodiment includes an electrophotographic photoreceptor that has a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer, a charging device that charges the electrophotographic photoreceptor by applying an alternating current using a charging roll, a direct transfer roll, and a recording medium peeling member that peels a recording medium from the direct transfer roll, in which a resistance value of the undercoat layer is 6.0 log Ω·m or more and 9.5 log Ω·m or less, and a current density of the electrophotographic photoreceptor at 40 V/μm is 0.012 μA/cm² or more and 0.030 μA/cm² or less.

In the image forming apparatus of the related art, that includes a direct transfer roll and a recording medium peeling member, in a case where a recording medium such as paper is peeled off from the direct transfer roll after a toner is fixed, a voltage is applied to the recording medium peeling member to peel the recording medium. In a case where a resistance of the undercoat layer in the electrophotographic photoreceptor is high, charges are accumulated. Therefore, in a case where positive charges remaining on the paper after passing through the direct transfer roll and the recording medium peeling member are discharged at an end part of the recording medium during the peeling of the recording medium, and a history of the positive charges is given to the electrophotographic photoreceptor, a streak (hereinafter, also referred to as “peeling-discharge streak”) is generated during printing in the next cycle. On the other hand, in a case where the resistance of the undercoat layer is lowered in order to suppress the peeling-discharge streak, fogging occurs as a secondary defect.

In the image forming apparatus according to the present exemplary embodiment, since the resistance value of the undercoat layer is 6.0 log Ω·m or more and 9.5 log Ω·m or less, and the current density of the electrophotographic photoreceptor at 40 V/μm is 0.012 μA/cm² or more and 0.030 μA/cm² or less, the resistance of the entire electrophotographic photoreceptor in a high electric field is reduced, and thus both fogging suppressing property and peeling-discharge streak suppressing property are excellent even in a case where an undercoat layer having a high resistance is employed.

### Resistance Value of Undercoat Layer

Unless otherwise specified, the “resistance value” in the present disclosure represents a common logarithmic value of a volume resistivity.

In the image forming apparatus according to the present exemplary embodiment, the above-described resistance value of the undercoat layer is 6.0 log Ω·m or more and 9.5 log Ω·m or less; and from the viewpoint of the fogging suppressing property, for example, the resistance value is preferably 6.5 log Ω·m or more and 9.2 log Ω·m or less, more preferably 7.0 log Ω·m or more and 9.0 log Ω·m or less, and still more preferably 7.5 log Ω·m or more and 9.0 log Ω·m or less.

A method of measuring the resistance value of the undercoat layer in the present exemplary embodiment is as follows.

For the measurement of the volume resistivity by an alternating current impedance method, a measurement environment of a temperature of 22° C. and a relative humidity of 55% RH is used, and SI1287 electrochemical interface (manufactured by TOYO Corporation) is used as a power supply, SI1260 impedance/gain phase analyzer (manufactured by TTOYO Corporation) is used as a current meter, and 1296 dielectric interface (manufactured by TOYO Corporation) is used as a current amplifier. In an alternating current impedance sample, an aluminum substrate is set as a cathode and a gold electrode is set as an anode, and an alternating current voltage of 1 Vp-p is applied from a high frequency side in a frequency range from 1 MHz to 1 mHz to measure an alternating current impedance of each sample. A graph of a Cole-Cole plot obtained from the measurement is fitted to an RC parallel equivalent circuit to calculate the volume resistivity.

### Current Density of Electrophotographic Photoreceptor at 40 V/μm

In the image forming apparatus according to the present exemplary embodiment, the above-described current density of the electrophotographic photoreceptor at 40 V/μm is 0.012 μA/cm² or more and 0.030 μA/cm² or less, and from the viewpoint of the peeling-discharge streak suppressing property, for example, the current density is preferably 0.012 μA/cm² or more and 0.028 μA/cm² or less, and more preferably 0.015 μA/cm² or more and 0.025 μA/cm² or less.

A method of measuring the current density of the electrophotographic photoreceptor at 40 V/μm in the present exemplary embodiment is as follows.

The photoreceptor and the charging roll are brought into contact with each other and rotated as in the actual machine, and while a voltage of 0 V to −1500 V is applied to the charging roll in increments of 10 V using a high-voltage power supply 610C manufactured by Trek, Inc., a voltage value of a surface of the photoreceptor is measured with a surface potential meter (surface potential meter Model 344 manufactured by Trek, Inc.). In this case, a voltage value (VH1) of a surface of the photoreceptor after 75 msec from the charging is measured. In addition, a voltage value of the surface of the photoreceptor after 339.8 msec from the VH1 measurement is defined as VH2, and a difference between VH2 and VH1 is defined as a potential dark decay value. In a case where VH1 at each of the above-described applied voltages is divided by the measured total film thickness of the photoreceptor (Film thickness of the undercoat layer+Film thickness of the charge generation layer+Film thickness of the charge transport layer), an electric field (V/μm) is calculated. In addition, the potential dark decay value for each of the above-described applied voltages is converted, and a current value (current density) flowing in a unit area (cm²) is calculated. By the above method, the current density in a case where the surface potential of the photoreceptor is divided by the total film thickness to be 40 V/μm is calculated.

### Voltage of Recording Medium Peeling Member

In the image forming apparatus according to the present exemplary embodiment, from the viewpoint of the peeling-discharge streak suppressing property, for example, the above-described voltage of the recording medium peeling member is preferably 100 V or more and 1,000 V or less, more preferably 200 V or more and 900 V or less, still more preferably 300 V or more and 800 V or less, and particularly preferably 400 V or more and 700 V or less.

### Transfer Current of Direct Transfer Roll

In the image forming apparatus according to the present exemplary embodiment, from the viewpoint of the fogging suppressing property and the peeling-discharge streak suppressing property, for example, the above-described transfer current of the direct transfer roll is preferably 2 μA or more and 18 μA or less, more preferably 5 μA or more and 15 μA or less, and particularly preferably 8 μA or more and 12 μA or less.

### Resistance Value of Recording Medium Used

In the image forming apparatus according to the present exemplary embodiment, from the viewpoint of the peeling-discharge streak suppressing property, for example, a resistance value (a common logarithmic value of a volume resistivity) of the recording medium to be used is preferably 1 log Ω·m or more and 20 log Ω·m or less, more preferably 2 log Ω·m or more and 15 log Ω·m or less, still more preferably 4 log Ω·m or more and 12 log Ω·m or less, and particularly preferably 4 log Ω·m or more and 10 log Ω·m or less.

Angle Formed by Direction of Pair of Transport Rolls Transporting Recording Medium after Passing Through Direct Transfer Roll and Recording Medium Transport Direction Immediately after Transfer

In the image forming apparatus according to the present exemplary embodiment, from the viewpoint of the peeling-discharge streak suppressing property, for example, an angle (deflection angle) formed by a direction of a pair of transport rolls transporting the recording medium after passing through the direct transfer roll and a recording medium transport direction immediately after the transfer is preferably 5° or more and 400 or less, more preferably 10° or more and 300 or less, and particularly preferably 150 or more and 300 or less.

In a case where the angle formed during the transport of the recording medium after the transfer is within the range of the above-described angle, discharge to the direct transfer roll is likely to occur at an end part of the recording medium, and thus the effects of the present exemplary embodiment are further exhibited.

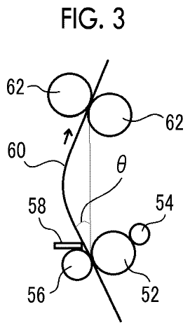

FIG. 3 is a schematic enlarged partial cross-sectional view in the example of the image forming apparatus according to the present exemplary embodiment.

An electrophotographic photoreceptor 52 in FIG. 3 includes a charging device 54 and a direct transfer roll 56, and the direct transfer roll 56 is provided with a recording medium peeling member 58.

The recording medium 60 is peeled off from the direct transfer roll 56 by the recording medium peeling member 58, and is transported to a pair 62 of transport rolls.

In addition, an angle formed by a direction of the pair 62 of transport rolls transporting the recording medium 60 after passing through the direct transfer roll 56 and a transport direction of the recording medium 60 immediately after the transfer is 0.

Hereinafter, the image forming apparatus according to the present exemplary embodiment will be described in more detail.

### Electrophotographic Photoreceptor

The image forming apparatus according to the present exemplary embodiment is an electrophotographic photoreceptor having a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer.

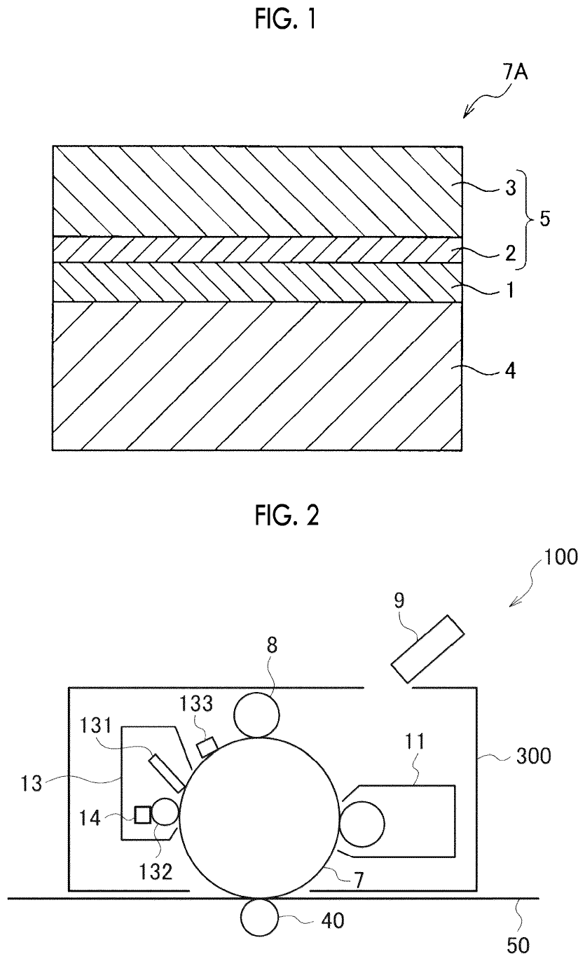

FIG. 1 is a partial cross-sectional view schematically showing an example of a layer configuration of the electrophotographic photoreceptor.

An electrophotographic photoreceptor 7 shown in FIG. 1 includes a lamination-type photosensitive layer.

Examples of the electrophotographic photoreceptor 7 shown in FIG. 1 include a photoreceptor 7 having a structure in which an undercoat layer 1, a charge generation layer 2, and a charge transport layer 3 are laminated in this order on a conductive support 4. The charge generation layer 2 and the charge transport layer 3 constitute a photosensitive layer 5.

Hereinafter, each layer of the electrophotographic photoreceptor will be described in detail. However, each layer of the photoreceptor will be described without a reference numeral.

The electrophotographic photoreceptor according to the present exemplary embodiment includes an undercoat layer containing a metal oxide on the conductive substrate, a charge generation layer containing a metal element provided on the undercoat layer, and a charge transport layer provided on the charge generation layer.

### Undercoat Layer

The undercoat layer is, for example, a layer containing a metal oxide and a binder resin.

Examples of the metal oxide include a metal oxide having a powder resistance (volume resistivity) of 10² Ω·cm or more and 10¹¹ Ω·cm or less.

Among the above, as the metal oxide having the above-described resistance value, for example, metal oxide particles such as tin oxide particles, titanium oxide particles, zinc oxide particles, and zirconium oxide particles are preferable, and zinc oxide particles are particularly preferable.

A specific surface area of the metal oxide particles, measured by a BET method, may be, for example, 10 m²/g or more.

A volume-average particle diameter of the metal oxide particles is, for example, preferably 50 nm or more and 2,000 nm or less (more preferably 60 nm or more and 1,000 nm or less).

A content of the metal oxide is, for example, preferably 10% by mass or more and 80% by mass or less, and more preferably 40% by mass or more and 80% by mass or less with respect to the binder resin.

The metal oxide particles may be subjected to a surface treatment. As the metal oxide particles, two or more kinds of metal oxide particles subjected to different surface treatments or two or more kinds of metal oxide particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the metal oxide from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the metal oxide, or in a state of being attached to the surface of the metal oxide particles.

Examples of a method of attaching the electron-accepting compound to the surface of the metal oxide particles include a dry method and a wet method.

The dry method is, for example, a method of attaching the electron-accepting compound to the surface of the metal oxide particles by adding the electron-accepting compound dropwise to the inorganic particles directly or by dissolving the electron-accepting compound in a solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the metal oxide particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the metal oxide particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the metal oxide particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the metal oxide particles as described above, but may be further added to the undercoat layer as the additive.

Examples of the silane coupling agent as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

For example, the undercoat layer has a Vickers hardness of 35 or more.

For example, the surface roughness (ten-point average roughness) of the undercoat layer may be adjusted to 1/2 from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method in the related art is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the metal oxide particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

An interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method in the related art is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

The charge generation layer is, for example, a layer containing a charge generation material containing a metal element, and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material containing a metal element include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method in the related art is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

The charge transport layer is a layer containing a binder resin and a charge transport material.

### Charge Transport Material

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

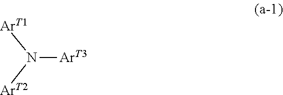

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}) or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

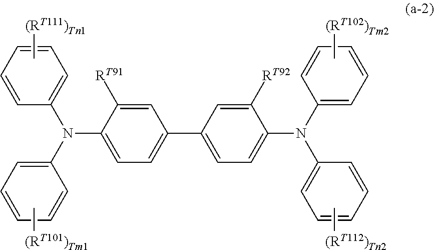

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}) or_CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tₘ₁, Tₘ₂, Tₙ₁, and Tₙ₂ each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

The charge transport material may be a polymer.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method in the related art is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

The film thickness of each layer of the photosensitive layer is an arithmetic average of measured values measured with an eddy current thickness meter, and measurement points are four points in a circumferential direction at intervals of 90° in the center of the photoreceptor in the axial direction. The measurement can be performed using, for example, a eddy current film thickness meter FisherScope MMS PC2 manufactured by Fisher Scientific International, Inc.

In addition, the above-described electrophotographic photoreceptor may further include a surface protective layer.

A known protective layer is used as the surface protective layer.

### Conductive Substrate

For example, the electrophotographic photoreceptor according to the present exemplary embodiment preferably has the photosensitive layer on a conductive substrate.

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Charging Device

The image forming apparatus according to the present exemplary embodiment includes a charging device that charges the electrophotographic photoreceptor by applying an alternating current using a charging roll.

As the charging device, a known charging device can be used.

A layer configuration of the charging roll is not particularly limited. Examples of the charging roll include a charging roll in which a conductive elastic layer, a resistance layer, and a surface layer are sequentially formed on a surface of a conductive support. An adhesive may be used between the respective layers as necessary. The resistance layer functions to ensure uniform charging performance and leak resistance performance.

The above-described conductive support is a support that functions as an electrode and a support member of the charging roll, and contains a conductive material including a metal or an alloy such as aluminum, a copper alloy, and stainless steel; iron subjected to a plating treatment with chromium, nickel, or the like; a conductive resin; or the like. A diameter of the conductive support is, for example, preferably 5 mm or more and 9 mm or less, and more preferably 6 mm or more and 8 mm or less.

The above-described elastic layer and resistance layer are formed, for example, by dispersing a conductive agent in a rubber material. Examples of the rubber material include isoprene rubber, chloroprene rubber, epichlorohydrin rubber, butyl rubber, polyurethane rubber, silicone rubber, fluororubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene terpolymer rubber (EPDM), acrylonitrile-butadiene copolymer rubber (NBR), natural rubber, and blended rubber thereof. Among the above, polyurethane rubber, silicone rubber, EPDM, epichlorohydrin-ethylene oxide copolymer rubber, epichlorohydrin-ethylene oxide-allyl glycidyl ether copolymer rubber, NBR, and blends thereof are used. In particular, in the elastic layer, these rubber materials may be foamed or unfoamed.

As the conductive agent, an electron conductive agent or an ion conductive agent is used. Examples of the electron conductive agent include fine powder including carbon black such as ketjen black and acetylene black; thermally decomposed carbon, graphite; various conductive metals such as aluminum, copper, nickel, and stainless steel or alloys thereof; various conductive metal oxides such as tin oxide, indium oxide, titanium oxide, a tin oxide-antimony oxide solid solution, and a tin oxide-indium oxide solid solution; a substance obtained by performing a conduction treatment on the surface of an insulating material; and the like.

In addition, examples of the ion conductive agent include perchlorates and chlorates such as tetraethylammonium and lauryl trimethylammonium; and alkali metals such as lithium and magnesium, and perchlorates and chlorates of alkaline earth metals.

The conductive agent may be used alone or in combination of two or more kinds thereof.

In addition, an addition amount is not particularly limited, but in a case of the above-described electron conductive agent, for example, the addition amount is preferably in a range of 1 part by mass or more and 30 parts by mass or less, and more preferably in a range of 5 parts by mass or more and 25 parts by mass or less with respect to 100 parts by mass of the rubber material. On the other hand, in a case of the above-described ion conductive agent, the addition amount is, for example, preferably in a range of 0.1 parts by mass or more and 5.0 parts by mass or less, and more preferably in a range of 0.5 parts by mass or more and 3.0 parts by mass or less with respect to 100 parts by mass of the rubber material.

A layer thickness of the elastic layer is, for example, preferably 1.0 mm or more and 4.0 mm or less, and more preferably 2.0 mm or more and 3.0 mm or less. In addition, a layer thickness of the resistance layer is, for example, preferably 200 μm or more and 1,000 μm or less, and more preferably 300 μm or more and 600 μm or less.

A polymer material constituting the above-described surface layer is not particularly limited; and examples thereof include polyamide, polyurethane, polyvinylidene fluoride, a tetrafluoroethylene copolymer, polyester, polyimide, a silicone resin, an acrylic resin, polyvinyl butyral, an ethylene-tetrafluoroethylene copolymer, a melamine resin, fluororubber, an epoxy resin, polycarbonate, polyvinyl alcohol, cellulose, polyvinylidene chloride, polyvinyl chloride, polyethylene, and an ethylene vinyl acetate copolymer.

The above-described polymer material may be used alone, or two or more kinds thereof may be used by being mixed or copolymerized. In addition, a number-average molecular weight of the above-described polymer material is, for example, preferably in a range of 1,000 or more and 100,000 or less, and more preferably in a range of 10,000 or more and 50,000 or less.

The surface layer is formed by mixing a conductive agent used in the above-described elastic layer as the conductive agent and various fine particles with the above-described polymer material to form a composition. An addition amount thereof is not particularly limited, but for example, is preferably in a range of 1 part by mass or more and 50 parts by mass or less, and more preferably in a range of 5 parts by mass or more and 20 parts by mass or less with respect to 100 parts by mass of the polymer material.

As the above-described fine particles, metal oxides and composite metal oxides such as silicon oxide, aluminum oxide, and barium titanate, and polymeric fine powders of tetrafluoroethylene, vinylidene fluoride, or the like are used alone or in combination, but the fine particles are not particularly limited thereto.

A layer thickness of the surface layer is, for example, preferably 1 μm or more and 50 μm or less, and more preferably 3 μm or more and 20 μm or less.

Fluctuation of an outer diameter of the charging roll is greatly affected by the accuracy of the layer thickness of the elastic layer. By improving polishing accuracy of the elastic layer and accuracy of a mold for molding the elastic layer, the fluctuation of the outer diameter of the charging roll can be set to 0.1 mm or less.

In addition, the resistance (common logarithmic value) of the charging roll can be set to 9.0 log Ω·m or less by appropriately combining the materials constituting the surface layer, the elastic layer, and the resistance layer. Examples of a combination of the rubber material and the conductive agent constituting the elastic layer and the resistance layer include a single type of polar rubber such as epichlorohydrin-ethylene oxide copolymer rubber, epichlorohydrin-ethylene oxide-allyl glycidyl ether copolymer rubber, acrylonitrile-butadiene copolymer rubber, and polyurethane, or a blend of two or more types of the polar rubbers in combination with the ion conductive agent and carbon black. Examples of a combination of the polymer compound and the conductive agent constituting the surface layer include combinations of polyamide, polyurethane, polyester, or melamine resin with carbon black or the metal oxide.

### Direct Transfer Roll

The image forming apparatus according to the present exemplary embodiment includes a direct transfer roll.

The direct transfer roll is not particularly limited as long as it is a roll that directly transfers the image to the recording medium, and a known transfer roll is used.

### Recording Medium Peeling Member

The image forming apparatus according to the present exemplary embodiment includes a recording medium peeling member that peels the recording medium from the direct transfer roll.

The recording medium peeling member is a member that peels the recording medium such as paper from the direct transfer roll.

The recording medium peeling member is not particularly limited, and a known peeling member such as a blade-shaped member and a roll-shaped member is used.

As the image forming apparatus according to the present exemplary embodiment, a known image forming apparatus such as a cleaning device that cleans the surface of the electrophotographic photoreceptor by bringing a cleaning member into contact with the surface of the electrophotographic photoreceptor; an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a discharging device that discharges the surface of the electrophotographic photoreceptor by applying the discharge light after the transfer of the toner image and before the charging; or an apparatus including an electrophotographic photoreceptor heating member for increasing the temperature of the electrophotographic photoreceptor and decreasing the relative temperature is adopted.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

An example of the image forming apparatus according to the present exemplary embodiment will be shown below, but the present invention is not limited thereto. Hereinafter, among the parts shown in the drawing, main parts will be described, and others will not be described.

FIG. 2 is a view schematically showing a configuration of an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of the electrostatic latent image forming device), and a transfer device 40 (direct transfer device). In the image forming apparatus 100, the exposure device 9 is disposed at a position where the electrophotographic photoreceptor 7 can be exposed from the opening portion of the process cartridge 300, the transfer device 40 is disposed at a position facing the electrophotographic photoreceptor 7, and an image is transferred to the recording medium 50.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger using a conductive or semi-conductive charging roller is used. In addition, a known charger such as a non-contact type roller charger, and a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, that has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include a contact-type transfer charging device using a roller.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

In the following description, the synthesis, the production, the treatment, the measurement, and the like are carried out at normal temperature (25° C.±3C), unless otherwise specified.

### Example 1

### Formation of Undercoat Layer

An aluminum cylindrical tube having an outer diameter of 30 mm, a length of 340 mm, and a thickness of 1 mm is prepared as a conductive substrate.

100 parts by mass of zinc oxide particles (product name: Nano Tek ZnO, manufactured by C.J.Kasei CO., LTD.) are heated in a stainless steel beaker at 120° C. for 2 hours to perform preliminarily drying.

Next, the preliminarily dried zinc oxide particles are stirred, and 40 parts by mass of a 4% by mass toluene solution of N-β-(aminoethyl)-γ-aminopropyltrimethoxysilane (silane coupling agent) is sprayed onto the zinc oxide while stirring, and the mixture is stirred at 100° C. for 1 hour. Thereafter, a baking treatment is further performed at 175° C. for 1 hour, and the particles are crushed with a mortar.

Next, 25 parts by mass of the obtained zinc oxide surface-treated with the surface treatment agent, 10 parts by mass of a curing agent (blocked isocyanate, SUMIDUR 3175, manufactured by Sumitomo Bayer Urethane Co., Ltd.), 9 parts by mass of a butyral resin S-LEC BM-1 (manufactured by Sekisui Chemical Co., Ltd.), 60 parts by mass of methyl ethyl ketone, and an additive (EDHA: 4-ethoxy-1,2-dihydroxy-9,10-anthraquinone) are mixed, and the mixture is dispersed for 2 hours with a sand mill using glass beads of 1 mmφ to obtain a dispersion.

3 parts by mass of silicone balls “TOSPEARL 120 (NISSHO SANGYO Co., Ltd.)” and 0.01 parts by mass of silicone oil SH29PA (manufactured by Dow Corning Toray Co., Ltd.) are added to the obtained dispersion. In this manner, a coating solution for forming an undercoat layer is obtained.

The obtained coating solution for forming an undercoat layer is applied onto an aluminum cylindrical conductive substrate, and dried and cured at 160° C. for 60 minutes. As a result, an undercoat layer having a film thickness of 23.5 μm is formed.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, manufactured by Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped in and coated with the coating solution for forming a charge generation layer, and dried at normal temperature to form a charge generation layer having a layer thickness of 0.25 μm.

### Formation of Charge Transport Layer

Binder resin (polycarbonate resin (1) (viscosity-average molecular weight: 40,000, numerical values in structural formulae indicate molar ratios)): 20 parts
Charge transport material (CTM-1): 15 parts
Solvent (tetrahydrofuran (THF)): 600 parts

The above-described materials are stirred and mixed for 12 hours to obtain a coating solution for forming a charge transport layer. The charge generation layer is coated with the coating solution for forming a charge transport layer by dip coating under a condition of a room temperature of 28° C. Thereafter, hot air is blown to the coating film to dry the coating film, thereby forming a charge transport layer A having a layer thickness of 22 μm.

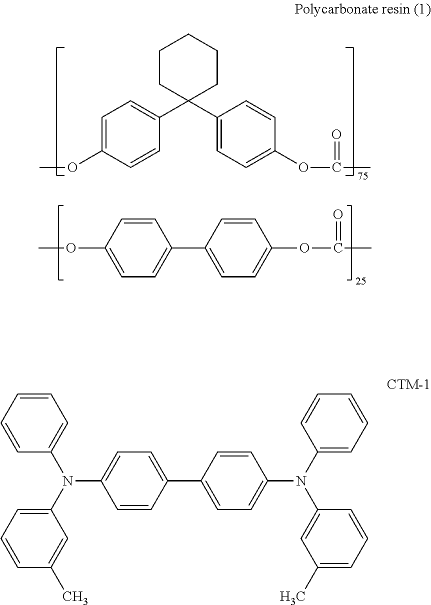

A photoreceptor is obtained through the above-described steps.

The photoreceptor is connected to a surface electrical characteristic evaluation device (scanner); the current density of the photoreceptor at an electric field of 40 V/μm is measured; the photoreceptor is mounted on a DocuPrint 3050 manufactured by FUJIFILM Business Innovation Corporation; and a voltage of the printed medium peeling member, a transfer current of the direct transfer roll, and a resistance of the printed medium are adjusted as shown in Table 1, thereby producing an image forming apparatus.

### Examples 2 to 10 and Comparative Examples 1 to 6

Each image forming apparatus is produced in the same manner as in Example 1, except that the type of the charge transport layer, the resistance of the undercoat layer, the current density of the photoreceptor at an electric field of 40 V/μm, the voltage of the printed medium peeling member, the transfer current of the direct transfer roll, and the resistance of the printed medium are changed as shown in Table 1.

Charge transport layers B and C are as shown below.

### Charge Transport Layer B

A charge transport layer B is formed in the same manner as the charge transport layer A, except that the content of the charge transport material is changed to 12 parts in the formation of the charge transport layer A.

### Charge Transport Layer C

A charge transport layer C is formed in the same manner as the charge transport layer A, except that the content of the charge transport material is changed to 10 parts in the formation of the charge transport layer A.

In addition, the resistance value of the undercoat layer is adjusted by the film thickness and the amount of zinc oxide added. In a case where the film thickness of the undercoat layer is increased, the resistance increases; and in a case where the film thickness of the undercoat layer is decreased, the resistance decreases. In addition, in a case where the amount of zinc oxide added is decreased, the resistance increases; and in a case where the amount of zinc oxide added is increased, the resistance increases.

### Evaluation of Fogging Suppressing Property and Peeling-Discharge Streak Suppressing Property

With a DocuPrint 3050 (manufactured by FUJIFILM Business Innovation Corporation, an image forming apparatus equipped with a direct transfer and recording medium peeling member (peeling discharge member, DTS)), an evaluation drum is attached to a process cartridge (CRU), and five predetermined charts (blank paper and a bicycle) are continuously output, and fogging and peeling-discharge streaks are visually evaluated.

### Fogging Suppressing Property

A: no fogging is observed.
B: some fogging is observed, but there is no problem in practical use.
C: fogging is observed, that is not acceptable in practical use.

### Peeling-Discharge Streak Suppressing Property

A: no streaks are observed.
B: some streaks are observed, but there is no problem in practical use.
C: streaks are observed, that is not acceptable in practical use.

TABLE 1

| | | | Current | Voltage of | Transfer | | | | |
|---|---|---|---|---|---|---|---|---|---|
| | | | density | recording | current of | | | | Peeling- |
| | Type of | Resistance of | at electric | medium | direct | Resistance | Angle of | | discharge |
| | charge | undercoat | field of | peeling | transfer | of printed | printed | Fogging | streak |
| | transport | layer | 40 V/μm | member | roll | member | member | suppressing | suppressing |
| | layer | (logΩ · m) | (μA/cm²) | (V) | (μA) | (logΩ · m) | (°) | property | property |
| Example 1 | A | 7.5 | 0.015 | 600 | 9 | 11.2 | 18 | A | A |
| Example 2 | A | 7.5 | 0.015 | 500 | 11 | 4.1 | 18 | A | B |
| Example 3 | A | 7.5 | 0.025 | 600 | 9 | 11.2 | 18 | A | A |
| Example 4 | A | 7.5 | 0.025 | 600 | 11 | 4.1 | 18 | A | A |
| Example 5 | A | 7.5 | 0.025 | 600 | 11 | 6.6 | 18 | A | A |
| Example 6 | A | 7.5 | 0.025 | 600 | 11 | 11.2 | 18 | A | A |
| Example 7 | A | 9.0 | 0.025 | 600 | 11 | 11.2 | 18 | A | A |
| Example 8 | A | 7.5 | 0.020 | 600 | 11 | 11.2 | 18 | A | A |
| Example 9 | A | 7.5 | 0.015 | 500 | 11 | 4.1 | 13 | A | A |
| Example 10 | A | 7.0 | 0.015 | 500 | 11 | 4.1 | 18 | A | B |
| Comparative | B | 7.5 | 0.010 | 500 | 11 | 4.1 | 18 | A | C |
| Example 1 | | | | | | | | | |
| Comparative | B | 7.5 | 0.010 | 600 | 9 | 11.2 | 18 | A | C |
| Example 2 | | | | | | | | | |
| Comparative | B | 5.0 | 0.025 | 500 | 11 | 4.1 | 18 | C | A |
| Example 3 | | | | | | | | | |
| Comparative | B | 5.0 | 0.025 | 600 | 9 | 11.2 | 18 | C | A |
| Example 4 | | | | | | | | | |
| Comparative | C | 5.0 | 0.010 | 500 | 11 | 4.1 | 18 | C | C |
| Example 5 | | | | | | | | | |
| Comparative | C | 5.0 | 0.010 | 600 | 9 | 11.2 | 18 | C | C |
| Example 6 | | | | | | | | | |

From the above results, it is found that the image forming apparatuses of Examples are excellent in fogging suppressing property and peeling-discharge streak suppressing property as compared with the image forming apparatuses of Comparative Examples.
(((1))) An image forming apparatus comprising:
an electrophotographic photoreceptor that has a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer;
a charging device that charges the electrophotographic photoreceptor by applying an alternating current using a charging roll;
a direct transfer roll; and
a recording medium peeling member that peels a recording medium from the direct transfer roll,
wherein a resistance value of the undercoat layer is 6.0 log Ω·m or more and 9.5 log Ω·m or less, and
a current density of the electrophotographic photoreceptor at 40 V/μm is 0.012 μA/cm² or more and 0.030 μA/cm² or less.
(((2))) The image forming apparatus according to (((1))),
wherein the resistance value of the undercoat layer is 7.0 log Ω·m or more and 9.0 log Ω·m or less.
(((3))) The image forming apparatus according to (((2))),
wherein the resistance value of the undercoat layer is 7.5 log Ω·m or more and 9.0 log Ω·m or less.
(((4))) The image forming apparatus according to any one of (((1))) to (((3))),
wherein the current density of the electrophotographic photoreceptor at 40 V/μm is 0.015 μA/cm² or more and 0.025 μA/cm² or less.
(((5))) The image forming apparatus according to any one of (((1))) to (((4))),
wherein a voltage of the recording medium peeling member is 300 V or more and 800 V or less.
(((6))) The image forming apparatus according to any one of (((1))) to (((5))),
wherein a transfer current of the direct transfer roll is 5 μA or more and 15 μA or less.
(((7))) The image forming apparatus according to any one of (((1))) to (((6))),
wherein a resistance value of the used recording medium is 4 log Ω·m or more and 12 log Ω·m or less.
(((8))) The image forming apparatus according to any one of (((1))) to (((7))),
wherein an angle formed by a direction of a pair of transport rolls transporting the recording medium after passing through the direct transfer roll and a recording medium transport direction immediately after the transfer is 100 or more and 30° or less.
(((9))) The image forming apparatus according to (((8))),
wherein the angle formed by the direction of the pair of transport rolls transporting the recording medium after passing through the direct transfer roll and the recording medium transport direction immediately after the transfer is 15° or more and 30° or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoreceptor that has a photosensitive layer on a conductive substrate, the electrophotographic photoreceptor including an undercoat layer containing a metal oxide on the conductive substrate, a charge generation layer containing a metal element provided on the undercoat layer, and a charge transport layer provided on the charge generation layer;
a charging device that charges the electrophotographic photoreceptor by applying an alternating current using a charging roll;
a direct transfer roll; and
a recording medium peeling member that peels a recording medium from the direct transfer roll,
wherein a resistance value of the undercoat layer is 6.0 log Ω·m or more and 9.5 log Ω·m or less, and
a current density of the electrophotographic photoreceptor at 40 V/μm is 0.012 μA/cm² or more and 0.030 μA/cm² or less.

2. The image forming apparatus according to claim 1,
wherein the resistance value of the undercoat layer is 7.0 log Ω·m or more and 9.0 log Ω·m or less.

3. The image forming apparatus according to claim 2,
wherein the resistance value of the undercoat layer is 7.5 log Ω·m or more and 9.0 log Ω·m or less.

4. The image forming apparatus according to claim 1,
wherein the current density of the electrophotographic photoreceptor at 40 V/μm is 0.015 μA/cm² or more and 0.025 μA/cm² or less.

5. The image forming apparatus according to claim 1,
wherein a voltage of the recording medium peeling member is 300 V or more and 800 V or less.

6. The image forming apparatus according to claim 1,
wherein a transfer current of the direct transfer roll is 5 μA or more and 15 μA or less.

7. The image forming apparatus according to claim 1,
wherein a resistance value of the used recording medium is 4 log Ω·m or more and 12 log Ω·m or less.

8. The image forming apparatus according to claim 1,
wherein an angle formed by a direction of a pair of transport rolls transporting the recording medium after passing through the direct transfer roll and a recording medium transport direction immediately after the transfer is 10° or more and 30° or less.

9. The image forming apparatus according to claim 8,
wherein the angle formed by the direction of the pair of transport rolls transporting the recording medium after passing through the direct transfer roll and the recording medium transport direction immediately after the transfer is 15° or more and 30° or less.
